(19) United States
(12) Patent Application Publication
(10) Pub. No.: US 2026/0072960 A1
(43) Pub. Date: Mar. 12, 2026

(54) Evaluation Framework for Retrieval-Augmented Generation (RAG) Systems Leveraging Large Language Models

(71) Applicant: Oracle International Corporation, Redwood Shores, CA (US)

(72) Inventors: Xin Zhang, Seattle, WA (US); Zheng Wang, Sammamish, WA (US); Mengqing Guo, Redmond, WA (US); Yazhe Hu, Bellevue, WA (US); Tao Sheng, Bellevue, WA (US)

(73) Assignee: Oracle International Corporation, Redwood Shores, CA (US)

(21) Appl. No.: 18/951,903

(22) Filed: Nov. 19, 2024

Related U.S. Application Data
(60) Provisional application No. 63/691,893, filed on Sep. 6, 2024.

(51) Int. Cl. G06F 16/33; G06F 16/332; G06F 16/383

(52) U.S. Cl. CPC G06F 16/334; G06F 16/3325; G06F 16/383

(57) ABSTRACT

Techniques for evaluating Retrieval-Augmented Generation (RAG) systems are disclosed. A system performs a series of analysis operations associated with elements of a RAG system to evaluate the effectiveness of separate elements of the RAG system, and to evaluate the overall effectiveness of the RAG system. The system employs large language models (LLMs) and other analysis tools to generate metrics that indicate the effectiveness of the RAG system at various stages of operation. Based on these metrics, the system changes settings on the RAG system to improve performance.

### BENEFIT CLAIMS; RELATED APPLICATIONS; INCORPORATION BY REFERENCE

This application claims the benefit of U.S. Provisional Patent Application 63/691,893, filed Sep. 6, 2024, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to machine learning systems. In particular, the present disclosure relates to retrieval augmented generation system evaluation.

### BACKGROUND

Retrieval-Augmented Generation (RAG) agents are used in applications requiring dynamic access to external information during the response generation process. Traditional machine learning models, particularly large language models (LLMs), rely on static training data and may lack the ability to provide responses based on information that becomes available after the training phase. In contrast, RAG agents address this limitation by retrieving up-to-date information from external sources, making them particularly useful in fields where information is constantly evolving or too vast to be incorporated into a model's static knowledge. This makes RAG agents well-suited for applications, such as customer service chatbots, real-time data analysis, medical research, and personalized recommendation systems, where they retrieve and integrate relevant data on-demand, offering more precise and contextually relevant outputs.

RAG agents are commonly deployed in various sectors, such as healthcare, finance, and e-commerce, due to their ability to process and synthesize information from large databases in real-time. In healthcare, for instance, RAG agents can quickly access vast repositories of medical literature and patient data to support medical diagnoses or provide personalized treatment recommendations. This contrasts with more basic machine learning models that would be limited to the information they were trained on and unable to consider new research or patient-specific factors after the training period. In e-commerce, RAG agents enable personalized shopping experiences by analyzing current user behavior and historical data to suggest products, ensuring that recommendations remain relevant and timely. This retrieval-based approach significantly enhances the model's utility in domains where accuracy and up-to-date knowledge are desirable.

One of the distinctions between RAG agents and traditional machine learning models lies in their handling of data. Standard models operate within the confines of their training set and may struggle with novel queries that fall outside of their trained knowledge. In contrast, RAG agents are designed to overcome this limitation by retrieving data from external sources in real-time, making them highly adaptable to a wide range of queries. This retrieval mechanism allows RAG agents to augment their responses with fresh, domain-specific knowledge that would otherwise be unavailable to traditional models. As a result, RAG agents are capable of addressing a broader spectrum of questions with higher accuracy, particularly in domains where information evolves rapidly or is too extensive to be fully encapsulated within a training dataset.

The integration of agents into the RAG framework introduces enhanced flexibility and scalability compared to traditional machine learning models. While conventional models are often static and should be retrained to incorporate new data, RAG agents operate in a more dynamic fashion, augmenting their knowledge base through external retrieval mechanisms. This allows RAG agents to remain relevant in real-time environments, where the need for current information is desirable. Traditional models, by contrast, require frequent updates and retraining to maintain accuracy, a process that can be both time-consuming and computationally expensive. RAG agents provide a more efficient and scalable solution, as they leverage external data without needing to undergo constant retraining, making them ideal for applications requiring both precision and adaptability.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a machine learning engine in accordance with one or more embodiments;

FIG. 2 illustrates the operation of a machine learning engine in one or more embodiments;

FIG. 3 illustrates a system in accordance with one or more embodiments;

FIG. 4 illustrates an example set of operations for RAG system evaluation in accordance with one or more embodiments; and

FIG. 5 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. MACHINE LEARNING ARCHITECTURE
3. GENERATIVE MODELS
4. RAG SYSTEM EVALUATION ARCHITECTURE
5. EVALUATING A RAG SYSTEM
6. COMPUTER NETWORKS AND CLOUD NETWORKS
7. HARDWARE OVERVIEW
8. MISCELLANEOUS; EXTENSIONS

### 1. General Overview

One or more embodiments perform a series of novel analysis operations associated with elements of a RAG system to evaluate the effectiveness of separate elements of the RAG system, and to evaluate the overall effectiveness of the RAG system. Initially, the RAG system receives a query. The query may be a request for the RAG system to generate an answer to a question about a technology-related subject, for example. The RAG system selects an action from a set of available actions. For example, query may be broken into sub-queries and the RAG system may perform a search action related to one of the sub-queries. To determine whether the RAG system picked the best action, an embodiment leverages a large language model (LLM), providing the LLM with the set of available actions, information associated with the query (such as a sub-query or interpretation of the query), the selected action, and instructions. The instructions may indicate, for example, the expected format or boundaries for the response desired from the LLM. The LLM returns a metric that is consistent with the instructions. This metric is referred to as a core metric. The core metric represents the effectiveness of a portion of the RAG system by performing an analysis based on information internal to the RAG system before the retrieval phase begins, which is information that is unavailable the users of the RAG system.

One or more embodiments evaluate the effectiveness of the retrieval functions of a RAG system. The RAG system determines that a document is relevant to the query, and performs a retrieval operation. An embodiment performs a retrieval analysis to determine whether the RAG system is effective at choosing documents that are useful for responding to the query. The system creates this metric in part by using a query-to-document mapping to determine whether the retrieved document is mapped to a query that is similar to at least a portion of the first query. The system uses this determination to generate a retrieval metric that indicates the effectiveness of the retrieval process within the RAG system. By performing this analysis using information that is available internally to the RAG system, users have additional transparency into the effectiveness of the retrieval function without regard to other portions of the RAG system.

One or more embodiments evaluate the effectiveness of the response generation function of a RAG system. The RAG system provides the selected document and the query to an LLM, which the LLM uses to generate a response. The system submits the query, the document, the response, and instructions for response generation to an LLM. For example, this LLM may be a more sophisticated LLM than the LLM that generated the response. The instructions request an analysis of the relationship between the query and the first document. An example analysis may include an analysis of whether or not the document could be used to generate a response to the initial query, or whether the response generated can be reasonably derived from the document. These questions may indicate if the response is grounded in the document, or if the RAG system is experiencing hallucination. A response generation metric is generated using the results of this analysis.

One or more embodiments use the core metric, the retrieval metric, and the response generation metric to present an evaluation of the system to a user. For example, a composite metric may be generated and presented in a user interface to the user. Alternatively, all metrics may be displayed, allowing the user to determine which portions of the RAG system are operating effectively and which portions of the RAG system may require additional tuning or configuration.

One or more embodiments described in this Specification and/or recited in the claims may not be included in this General Overview section.

### 2. Machine Learning Architecture

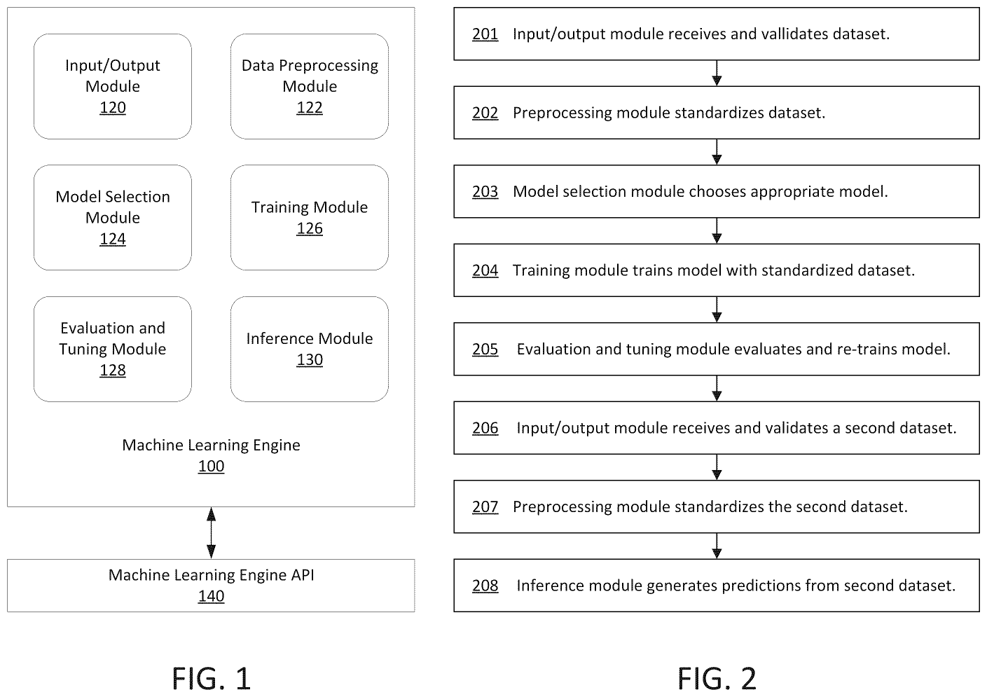

FIG. 1 illustrates a machine learning engine 100 in accordance with one or more embodiments. As illustrated in FIG. 1, machine learning engine 100 includes input/output module 120, data preprocessing module 122, model selection module 124, training module 126, evaluation and tuning module 128, and inference module 130.

In accordance with an embodiment, input/output module 120 serves as the primary interface for data entering and exiting the system, managing the flow and integrity of data. This module may accommodate a wide range of data sources and formats to facilitate integration and communication within the machine learning architecture.

In an embodiment, an input handler within input/output module 120 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 120 to be versatile in different operational contexts, whether processing historical datasets or streaming data.

In accordance with an embodiment, input/output module 120 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 120 includes an output framework designed to handle the distribution and exportation of outputs, predictions, or insights. Using the output framework, input/output module 120 formats these outputs into user-friendly and accessible formats, such as reports, visualizations, or data files compatible with other systems. Input/output module 120 also ensures secure and efficient transmission of these outputs to end-users or other systems in an embodiment and may employ encryption and secure data transfer protocols to maintain data confidentiality.

In accordance with an embodiment, data preprocessing module 122 transforms data into a format suitable for use by other modules in machine learning engine 100. For example, data preprocessing module 122 may transform raw data into a normalized or standardized format suitable for training ML models and for processing new data inputs for inference. In an embodiment, data preprocessing module 122 acts as a bridge between the raw data sources and the analytical capabilities of machine learning engine 100.

In an embodiment, data preprocessing module 122 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 122 may be configured to handle anomalies in different ways depending on context. Data preprocessing module 122 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 122 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 122 processes new data for inference, data preprocessing module 122 replicates the same preprocessing steps to ensure consistency with the training data format. This helps to avoid discrepancies between the training data format and the inference data format, thereby reducing the likelihood of inaccurate or invalid model predictions.

In an embodiment, model selection module 124 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 124 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 124 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 124 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 124 also considers computational efficiency and resource constraints. This is meant to help ensure the selected model is both accurate and practical in terms of computational and time requirements. In an embodiment, certain features of model selection module 124 are configurable such as a configured bias toward (or against) computational efficiency.

In accordance with an embodiment, training module 126 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 126 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 126 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 126 includes logic to handle different types of data and learning tasks. For instance, it includes different training routines for supervised learning (where the training data comes with labels) and unsupervised learning (without labeled data). In the case of deep learning models, training module 126 also manages the complexities of training neural networks that include initializing network weights, choosing activation functions, and setting up neural network layers.

In an embodiment, evaluation and tuning module 128 incorporates dynamic feedback mechanisms and facilitates continuous model evolution to help ensure the system's relevance and accuracy as the data landscape changes. Evaluation and tuning module 128 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 128 performs continuous model tuning by using hyperparameter optimization. Evaluation and tuning module 128 performs an exploration of the hyperparameter space using algorithms, such as grid search, random search, or more sophisticated methods like Bayesian optimization. Evaluation and tuning module 128 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 128 integrates data feedback and updates the model. Evaluation and tuning module 128 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 128 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 128 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 130 transforms data raw data into actionable, precise, and contextually relevant predictions. In addition to processing and applying a trained model to new data, inference module 130 may also include post-processing logic that refines the raw outputs of the model into meaningful insights.

In an embodiment, inference module 130 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 130 transforms the outputs of a trained model into definitive classifications. Inference module 130 employs the underlying model as a tool to generate probabilistic outputs for each potential class. It then engages in an interpretative process to convert these probabilities into concrete class labels.

In an embodiment, when inference module 130 receives the probabilistic outputs from the model, it analyzes these probabilities to determine how they are distributed across some or every potential class. If the highest probability is not significantly greater than the others, inference module 130 may determine that there is ambiguity or interpret this as a lack of confidence displayed by the model.

In an embodiment, inference module 130 uses thresholding techniques for applications where making a definitive decision based on the highest probability might not suffice due to the critical nature of the decision. In such cases, inference module 130 assesses if the highest probability surpasses a certain confidence threshold that is predetermined based on the specific requirements of the application. If the probabilities do not meet this threshold, inference module 130 may flag the result as uncertain or defer the decision to a human expert. Inference module 130 dynamically adjusts the decision thresholds based on the sensitivity and specificity requirements of the application, subject to calibration for balancing the trade-offs between false positives and false negatives.

In accordance with an embodiment, inference module 130 contextualizes the probability distribution against the backdrop of the specific application. This involves a comparative analysis, especially in instances where multiple classes have similar probability scores, to deduce the most plausible classification. In an embodiment, inference module 130 may incorporate additional decision-making rules or contextual information to guide this analysis, ensuring that the classification aligns with the practical and contextual nuances of the application.

In regression models, where the outputs are continuous values, inference module 130 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 130 incorporates domain-specific adjustments into its post-processing routine. This involves tailoring the model's output to align with specific industry knowledge or contextual information. For example, in financial forecasting, inference module 130 may adjust predictions based on current market trends, economic indicators, or recent significant events, ensuring that the outputs are both statistically accurate and practically relevant.

In an embodiment, inference module 130 includes logic to handle uncertainty and ambiguity in the model's predictions. In cases where inference module 130 outputs a measure of uncertainty, such as in Bayesian inference models, inference module 130 interprets these uncertainty measures by converting probabilistic distributions or confidence intervals into a format that can be easily understood and acted upon. This provides users with both a prediction and an insight into the confidence level of that prediction. In an embodiment, inference module 130 includes mechanisms for involving human oversight or integrating the instance into a feedback loop for subsequent analysis and model refinement.

In an embodiment, inference module 130 formats the final predictions for end-user consumption. Predictions are converted into visualizations, user-friendly reports, or interactive interfaces. In some systems, like recommendation engines, inference module 130 also integrates feedback mechanisms, where user responses to the predictions are used to continually refine and improve the model, creating a dynamic, self-improving system.

FIG. 2 illustrates the operation of a machine learning engine in one or more embodiments. In an embodiment, input/output module 120 receives a dataset intended for training (Operation 201). This data can originate from diverse sources, like databases or real-time data streams, and in varied formats, such as CSV, JSON, or XML. Input/output module 120 assesses and validates the data, ensuring its integrity by checking for consistency, data ranges, and types.

In an embodiment, training data is passed to data preprocessing module 122. Here, the data undergoes a series of transformations to standardize and clean it, making it suitable for training ML models (Operation 202). This involves normalizing numerical data, encoding categorical variables, and handling missing values through techniques like imputation.

In an embodiment, prepared data from the data preprocessing module 122 is then fed into model selection module 124 (Operation 203). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 126 trains the selected model with the prepared dataset (Operation 204). It implements learning algorithms to adjust the model's internal parameters, optimizing them to identify patterns and relationships in the training data. Training module 126 also addresses the challenge of overfitting by implementing techniques, like regularization and early stopping, ensuring the model's generalizability.

In an embodiment, evaluation and tuning module 128 evaluates the trained model's performance using the validation dataset (Operation 205). Evaluation and tuning module 128 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 120 receives a dataset intended for inference. Input/output module 120 assesses and validates the data (Operation 206).

In an embodiment, data preprocessing module 122 receives the validated dataset intended for inference (Operation 207). Data preprocessing module 122 ensures that the data format used in training is replicated for the new inference data, maintaining consistency and accuracy for the model's predictions.

In an embodiment, inference module 130 processes the new data set intended for inference, using the trained and tuned model (Operation 208). It applies the model to this data, generating raw probabilistic outputs for predictions. Inference module 130 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 140 allows for applications to leverage machine learning engine 100. In an embodiment, machine learning engine API 140 may be built on a RESTful architecture and offer stateless interactions over standard HTTP/HTTPS protocols. Machine learning engine API 140 may feature a variety of endpoints, each tailored to a specific function within machine learning engine 100. In an embodiment, endpoints such as /submitData facilitate the submission of new data for processing, while /retrieveResults is designed for fetching the outcomes of data analysis or model predictions. The MLE API may also include endpoints like /pdateModel for model modifications and /trainModel to initiate training with new datasets.

In an embodiment, machine learning engine API 140 is equipped to support SOAP-based interactions. This extension involves defining a WSDL (Web Services Description Language) document that outlines the API's operations and the structure of request and response messages. In an embodiment, machine learning engine API 140 supports various data formats and communication styles. In an embodiment, machine learning engine API 140 endpoints may handle requests in JSON format or any other suitable format. For example, machine learning engine API 140 may process XML, and it may also be engineered to handle more compact and efficient data formats, such as Protocol Buffers or Avro, for use in bandwidth-limited scenarios.

In an embodiment, machine learning engine API 140 is designed to integrate WebSocket technology for applications necessitating real-time data processing and immediate feedback. This integration enables a continuous, bi-directional communication channel for a dynamic and interactive data exchange between the application and machine learning engine 100.

### 3. Generative Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 120, when used for large language models, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 122 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 124, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 126, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 128 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 130, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

The self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 4. Rag System Evaluation Architecture

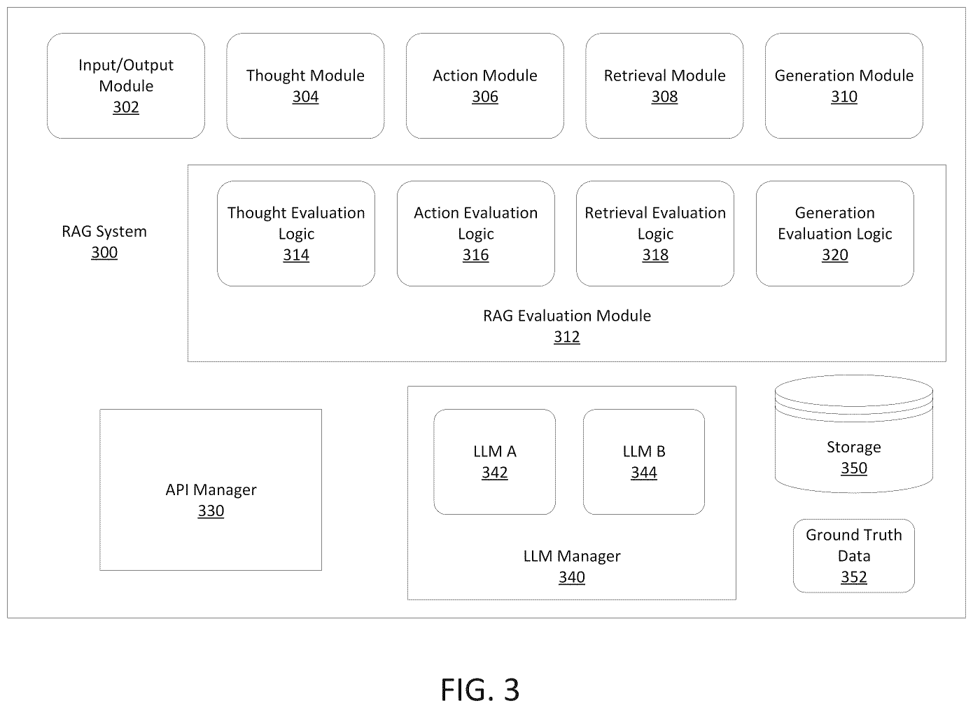

FIG. 3 illustrates a RAG system 300 in accordance with one or more embodiments. As illustrated in FIG. 3, RAG system 300 includes input/output module 302, thought module 304, action module 306, retrieval module 308, generation module 310, rag evaluation module 312, API manager 330, LLM manager 340, storage 350, and ground truth data 352. RAG evaluation module 312 includes thought evaluation logic 314, action evaluation logic 316, retrieval evaluation logic 318, and generation evaluation logic 320. LLM manager 340 includes LLM A 340 and LLM B 342.

In accordance with one or more embodiments, RAG system 300 operates by integrating a retrieval mechanism and a generative model. The retrieval mechanism is responsible for searching a predefined dataset, such as a large corpus of documents or a knowledge base, to identify relevant information based on a user query or prompt. This process involves indexing the corpus and using algorithms, such as term frequency-inverse document frequency (TF-IDF) or more advanced neural retrieval models, to rank documents or passages by relevance to the input query.

In accordance with one or more embodiments, once relevant documents are identified, RAG system 300 feeds this information into a generative model. The generative model, often based on architectures like Transformer networks, processes the retrieved information in conjunction with the original query to produce a contextually informed output.

The model uses the information provided by the retrieval mechanism as additional context, enhancing its ability to generate responses that are both factually accurate and relevant to the query. This method allows the generative model to leverage up-to-date or domain-specific information that it may not have been trained on directly, improving the specificity and accuracy of its outputs.

In accordance with one or more embodiments, RAG system 300 is designed to operate in a pipeline where the retrieval and generation stages are connected, allowing for dynamic retrieval of information during the generation process. The generative model can refine its output iteratively, adjusting based on the retrieved information and the context provided by the query. This approach enables the generation of detailed responses that are directly tied to the most relevant information available in the dataset, rather than relying solely on the pre-existing knowledge embedded in the generative model's parameters. Components of RAG system 300 are discussed in more detail below.

In accordance with one or more embodiments, input/output module 302 serves as the primary interface for data entering and exiting the system, managing the flow and integrity of data. Input/output module 302 may accommodate a wide range of data sources and formats to facilitate integration and communication within the system architecture.

In an embodiment, an input handler within input/output module 302 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 302 to be versatile in different operational contexts, whether processing historical datasets or streaming data.

In accordance with an embodiment, input/output module 302 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 302 includes an output framework designed to handle the distribution and exportation of outputs, predictions, or insights. Using the output framework, input/output module 302 formats these outputs into user-friendly and accessible formats, such as reports, visualizations, or data files compatible with other systems. Input/output module 302 also ensures secure and efficient transmission of these outputs to end-users or other systems in an embodiment and may employ encryption and secure data transfer protocols to maintain data confidentiality.

In accordance with one or more embodiments, thought module 304 is configured to generate “thoughts” associated with the query. Thoughts are intermediate reasoning outcomes that represent information extracted from or deduced from a query. For example, if a query asks who won the men's basketball gold medal in the most recent Olympic games, some thoughts that may be generated by thought module 304 may include “when were the most recent Olympic games? ” and “men's basketball gold medal.” Thought module 304 includes a machine learning model that is trained to generate thoughts in response to queries. Training thought module's machine learning model may include providing thought module 304 with a training data set based on human interpretations of queries in an embodiment.

In accordance with one or more embodiments, action module 306 is configured to convert thoughts into actions. In an embodiment, actions are chosen from a set of actions stored in memory or a storage mechanism such as storage 350. Actions are actions that may be taken by RAG system 300 in response to a thought. For example, actions may include search, generate, reflect, or any other action that may follow from a thought. For example, the search action may leverage a search API to access information that may help RAG system 300 respond to the query. The action may be to search for “men's basketball gold medal” based on the previous example.

Action module 306 selects the action using a mapping between thought keywords and actions in accordance with one or more embodiments. In an embodiment, action module 306 includes a machine learning model trained to select actions from thoughts. Training action module 306's machine learning model may include providing action module 306 with a training data set based on human actions selected in response to thoughts in an embodiment. Action module includes action-to-API logic that initiates an action using an API that is associated with the action. For example, if the chosen action is to search, the action-to-API logic will initiate a connection via a search API.

In accordance with one or more embodiments, retrieval module 308 is configured for identifying and returning relevant information from an external or internal data source in response to a user's query. When a query is received, it is first tokenized, breaking down the input text into a sequence of tokens that can be processed by the system. These tokens are then converted into a vector representation using an embedding model, typically one that has been pre-trained on a large corpus to understand semantic relationships between words and phrases. This vector representation captures the essence of the user's query and is used to search through a database of precomputed document embeddings. The retrieval module 308 uses a similarity metric, such as cosine similarity or dot-product similarity, to compare the query vector with the document embeddings, ranking the documents based on their relevance to the query.

In an embodiment, retrieval module 308 relies on efficient nearest-neighbor search algorithms, like those implemented in FAISS or ScaNN, to quickly identify and return the top-ranked documents or text passages. The retrieval process is designed to be both fast and scalable, enabling the system to handle large datasets and return results within a fraction of a second. The output of retrieval module 308 is a set of documents or text passages that are accompanied by a relevance score that indicates how closely it matches the user's query. These documents serve as additional context for the subsequent generation phase.

In accordance with one or more embodiments, generation module 310 is responsible for producing the final output that is presented to the user. Generation module 310 takes the original user query, along with the documents retrieved by retrieval module 308, and processes them to generate a coherent response. A generative model within generation module 310 is based on a Transformer architecture that is used for handling sequential data and generating text. The model receives the concatenated input that may include the user query, thoughts, and/or the retrieved documents, and tokenizes this combined input into a sequence of tokens.

In accordance with one or more embodiments, tokenized input is then passed through multiple layers of the Transformer model. The layers consist of self-attention mechanisms and feed-forward neural networks that work together to refine the model's understanding of the input sequence. The self-attention mechanism allows the model to focus on different parts of the input sequence, dynamically adjusting the attention it pays to the tokens based on its relevance to the current token being generated. This enables the model to incorporate information from the retrieved documents, integrating it with the user query to produce a contextually informed response.

In accordance with one or more embodiments, as the model processes the input through its layers, it generates a probability distribution over its vocabulary for the tokens in the output sequence. The generation module 310 then samples from this distribution, selecting the most likely token at each step to build the final response. The output tokens are then detokenized, converting them back into human-readable text.

In accordance with one or more embodiments, generation module 310 relies on the information provided by retrieval module 308 to ensure that the generated response is accurate and relevant to the user's query. By incorporating the retrieved documents into its processing, the generation module 310 is able to produce responses that are based on the pre-trained knowledge of the generative model and enriched by the up-to-date or domain-specific information provided by the retrieval module 308. The interaction between these two modules allows RAG agent 370 to handle a wide range of queries, providing responses that are both informed and contextually appropriate.

In accordance with one or more embodiments, RAG evaluation module 312 includes logic for evaluating features of RAG system 300. RAG evaluation module 312 includes logic for evaluating the operation of RAG system 300 at important stages in an embodiment.

In accordance with one or more embodiments, thought evaluation logic 314 is configured to evaluate the quality of thoughts generated by thought module 304. Thought evaluation logic 314 performs a query deconstruction analysis in an embodiment. For example, thought evaluation logic 314 accesses a query-to-sub-query mapping to determine if one or more sub-queries in the mapping are similar to thoughts generated in response to a query. The mapping may also be referred to as a query-to-thought mapping. In accordance with one or more embodiments, the query-to-sub-query mapping is generated either by a sophisticated LLM or by human review of potential queries that may be expected by the RAG system 300. In an embodiment, an LLM may be used to perform the analysis on the conversion of queries to thoughts instead of using a query-to-sub-query mapping. By performing a comparison between the thoughts generated by thought module 304 and the query-to-sub-query mapping, or by leveraging an LLM trained to analyze the conversion of a query to thoughts, thought evaluation logic may generate a metric that indicates the effectiveness of the query deconstruction or query analysis process.

In accordance with one or more embodiments, action evaluation logic 316 is configured to perform an analysis of the output of action module 306. For example, given a particular thought, action module 306 will select an action from a set of actions to be taken to help generate a response to the query. Action evaluation logic 316 accesses an LLM that is trained to recognize appropriate actions in response to thoughts associated with queries. In an embodiment, action evaluation logic provides to the LLM a set of available actions, information associated with the query, such as thoughts, the action that was selected by action module 306 in response to that information associated with the query, and instructions for metric generation. By providing instructions for metric generation, the metric can be based on any scale. For example, the LLM may return a 1 if the correct action was chosen and a zero if the correct action was not chosen.

In accordance with one or more embodiments, retrieval evaluation logic 318 is configured to generate a retrieval metric that indicates the effectiveness of the document retrieval process used by retrieval module 308. Retrieval evaluation logic 318 accesses a query-to-document mapping that maps expected queries to documents. The query-to-document mapping indicates which document is a document associated with a particular expected query. The mapping may be created by humans reviewing the available documents and then providing expected queries that may be answered by the documents. These are known as “ground truth” documents for the mapped query. Ground truth information can be stored in ground truth data 352, which is a data set within storage 350 in an embodiment.

In accordance with one or more embodiments, retrieval evaluation logic 318 compares thoughts and/or sub-queries generated by thought module 304 with queries in the query-to-document mapping to determine which documents are ground truth documents for the sub-queries or thoughts. Retrieval evaluation logic determines if one of the documents selected by retrieval module 318 is a ground truth document. A metric is used to indicate if the retrieval was effective. Over a number of queries, the effectiveness of the retrieval module 308 can be determined by tracking the percentage of queries that resulted in retrieval of a ground truth document for the particular query.

In accordance with one or more embodiments, retrieval module 308 may select a set of documents deemed to be relevant to the query. Retrieval evaluation logic 318 may generate a mean reciprocal rank (MRR) score for a set of queries over time. This may be performed by determining the rank of highest-ranking document that is a ground truth document. For example, if three documents are selected by retrieval module 308 and the highest-ranking document is not a ground truth document for the query, but the second document and the third document are both ground truth documents for the query, then the second document is identified as the highest-ranking ground truth document.

In an embodiment, MRR is then used to assess the performance of retrieval module 308. It evaluates the rank of the first relevant result in a list of search results. MRR is calculated by determining the reciprocal rank for each query, which is the inverse of the rank position of the first relevant item. For example, if the first relevant result appears in the second position, the reciprocal rank is 0.5. To calculate MRR, the average of the reciprocal ranks across the queries is taken. This involves summing the reciprocal ranks and dividing by the total number of queries. For instance, if three queries have relevant results in the first, third, and second positions, the MRR would be the average of 1, 0.33, and 0.5, resulting in approximately 0.61. MRR provides a clear measure of an algorithm's effectiveness. An MRR of 1 indicates that the relevant result consistently appears as the top result, representing optimal performance. Lower MRR values suggest that relevant results are appearing further down the list, indicating less effective ranking by the algorithm. This metric is particularly useful in systems where identifying the first relevant item is important.

In accordance with one or more embodiments, generation evaluation logic 320 is configured to generate a generation metric that indicates the effectiveness of generation module 310. To generate a generation metric, generation evaluation logic 320 leverages an LLM, such as LLM A 342 or LLM B 344. These LLMs may be any large language model, including state-of-the-art LLMs. In an embodiment, generation evaluation logic 320 submits, to the selected LLM the document retrieved, the initial query submitted to the RAG system 300, along with instructions. To generate an answerability metric, the generation evaluation logic 320 will use instructions that tell the LLM to indicate if the query can be effectively responded to by using the information in the retrieved document. The answerability metric can be a binary yes/no, or it may be a ranking that indicates how well the query can be answered by the document. To generate a grounding metric or hallucination metric, generation evaluation logic 320 submits the retrieved document and the query response, along with instructions. The instructions sent to the LLM by generation evaluation logic 320 may request that the LLM determine if the answer provided in response to the query is grounded in the retrieved document. Stated another way, the question posed to the LLM asks if the information presented to the user in response to the query can even be derived from the document.

In accordance with one or more embodiments, API manager 330 is responsible for coordinating and managing the operations of multiple APIs, allowing components to utilize various APIs for tasks, such as search, document retrieval, web scraping, data aggregation, sentiment analysis, and entity recognition. API manager 330 provides a centralized interface for API access, managing the distribution of requests across different APIs based on task-specific requirements, such as input type, output format, and data source. API manager 330 abstracts the underlying complexity of interacting with different APIs by offering standardized access methods, handling communication protocols, and managing API-specific configurations. API manager 330 oversees the integration of outputs from multiple APIs, managing load balancing, API selection, and potentially incorporating fallback mechanisms in case of API failures. API manager 330 also monitors the performance of APIs, collecting metrics and logs to optimize future interactions while managing version control and updates to ensure the most effective APIs are utilized. API manager 330 enables the integration of diverse APIs into larger systems, allowing components to leverage various information-gathering capabilities without managing the intricacies of the individual APIs.

In accordance with one or more embodiments, LLM manager 340 is responsible for coordinating and managing the operations of multiple large language models (LLMs), including LLM A 342, LLM B 344, and potentially other LLMs and machine learning models as needed. The manager provides a centralized interface through which components can access these models for various analysis tasks. The manager handles the distribution of requests among the models, ensuring that the appropriate model is utilized based on the specific requirements of the task, such as context, input type, or desired output. The operation may involve the orchestration of model pipelines where multiple models are employed sequentially or in parallel to achieve a composite analysis. LLM manager 340 abstracts the underlying complexity of managing different models, offering standardized access methods and managing load balancing, model selection, and integration of outputs from multiple models. This includes handling the communication protocols, managing model-specific configurations, and potentially incorporating fallback mechanisms in case of model failures. Additionally, the manager monitors the performance of the models, collecting metrics and logs to optimize future interactions, while also handling version control and updates to ensure that the most effective models are utilized.

Through these processes, LLM manager 340 enables the integration of LLMs and other machine learning models into larger systems, allowing components to leverage advanced capabilities without needing to manage individual model intricacies.

In one or more embodiments, storage 350 is any type of storage unit and/or device (e.g., a file system, database, collection of tables, or any other storage mechanism) for storing data. Furthermore, storage 350 may include multiple different storage units and/or devices. The multiple different storage units and/or devices may or may not be of the same type or located at the same physical site. Furthermore, storage 350 may be implemented or executed on the same computing system as RAG system 300. Additionally, or alternatively, a storage 350 may be implemented or executed on a computing system separate from RAG system 300. Storage 350 may be communicatively coupled to RAG system 300 via a direct connection or via a network.

In one or more embodiments, RAG system 300 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 6, titled “Computer Networks and Cloud Networks.”

Information describing RAG system 300 may be implemented across any of components within RAG system 300. However, this information is illustrated within the data storage 350 for purposes of clarity and explanation.

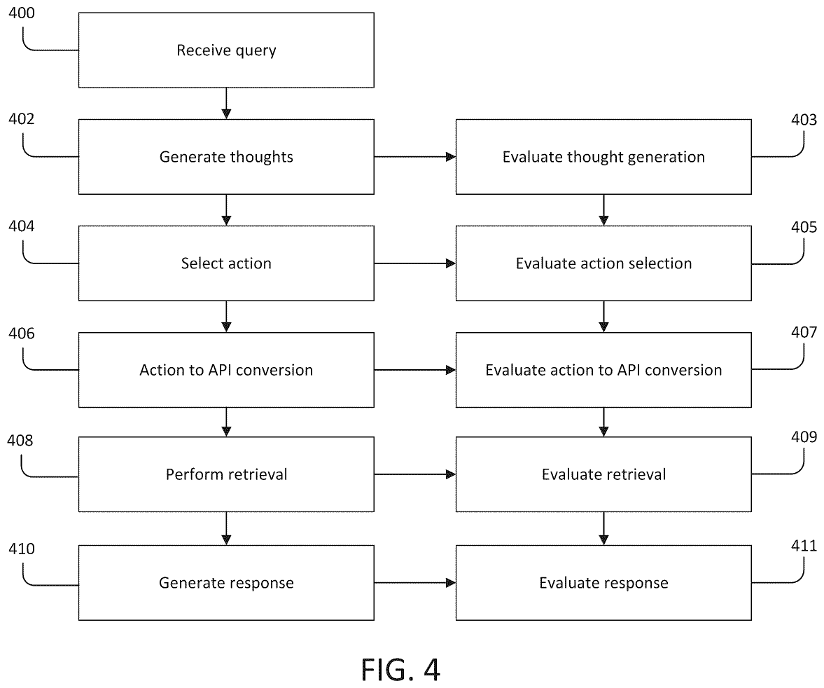

In one or more embodiments, RAG system 300 and the components shown therein refer to hardware and/or software configured to perform operations described herein for RAG system 300. Examples of operations for RAG system 300 are described below with reference to FIG. 4.

In an embodiment, RAG system 300 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, an interface may be used to interact with RAG system 300. An interface refers to hardware and/or software configured to facilitate communications between a user and RAG system 300. The interface renders user interface elements and receives input via user interface elements. Examples of interfaces include a graphical user interface (GUI), a command line interface (CLI), a haptic interface, and a voice command interface.

Examples of user interface elements include checkboxes, radio buttons, dropdown lists, list boxes, buttons, toggles, text fields, date and time selectors, command lines, sliders, pages, and forms.

In an embodiment, different components of the interface are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, the interface is specified in one or more other languages, such as Java, C, or C++.

### 5. Evaluating a Rag System

FIG. 4 illustrates an example set of operations for evaluating a RAG system in accordance with one or more embodiments. One or more operations illustrated in FIG. 4 may be modified, rearranged, or omitted. Accordingly, the particular sequence of operations illustrated in FIG. 4 should not be construed as limiting the scope of one or more embodiments.

In an embodiment, the system receives a query (Operation 400). The query may be a question, such as “Who won the gold medal for the women's all-around gymnastics competition in the 2024 Olympic games? ” In an embodiment, the system's components may be trained on documents specific to a particular subject or entity, such as sports or a particular company.

In an embodiment, the system generates thoughts (Operation 402). Given the example above, the system may generate thoughts such as “women's gymnastics, “2024 Olympic games,” and “gymnastics all-around champion. The system may generate thoughts using an LLM configured for thought generation and trained on a series of queries that have been broken down into sub-queries.

In an embodiment, the system evaluates thought generation (Operation 403). Thought evaluation logic 314 performs a query deconstruction analysis in an embodiment. For example, thought evaluation logic 314 accesses a query-to-sub-query mapping to determine if one or more sub-queries in the mapping are similar to thoughts generated in response to a query. The mapping may also be referred to as a query-to-thought mapping. In accordance with one or more embodiments, the query-to-sub-query mapping is generated either by a sophisticated LLM or by human review of potential queries that may be expected by the RAG system 300. In an embodiment, an LLM may be used to perform the analysis on the conversion of queries to thoughts instead of using a query-to-sub-query mapping. By performing a comparison between the thoughts generated by thought module 304 and the query-to-sub-query mapping, or by leveraging an LLM trained to analyze the conversion of a query to thoughts, thought evaluation logic may generate a metric that indicates the effectiveness of the query deconstruction or query analysis process.

In an embodiment, the system selects an action (Operation 404). The system selects an action from a set of available actions. For example, available actions may be search, generate, self-reflect, or any other potential action that may follow from a sub-query or thought. As an example, the thought “2024 Olympic games” may result in the selection of the search action, leading to a search for information on the 2024 Olympic games.

In an embodiment, the system evaluates the action selection (Operation 405). For example, given a particular thought, action module 306 will select an action from a set of actions to be taken to help generate a response to the query. Action evaluation logic 316 accesses an LLM that is trained to recognize appropriate actions in response to thoughts associated with queries. In an embodiment, action evaluation logic provides to the LLM a set of available actions, information associated with the query such as thoughts, the action that was selected by action module 306 in response to that information associated with the query, and instructions for metric generation. By providing instructions for metric generation, the metric can be based on any scale. For example, the LLM may return a 1 if the correct action was chosen and a zero if the correct action was not chosen.

In an embodiment, the system performs an action to API conversion (Operation 406). For example, if a search action is selected, the system may convert the search action into the proper form for a search operation to take place via a search API that connects the system to advanced search engine technology. In an embodiment, multiple APIs of the same type may be employed by the system. The system then selects the API to use for the action based on the context of the query. For example, if the query is about human resources, the system may use an API designed to interface with documents associated with human resources. A separate API may be used for other departments or document repositories.

In an embodiment, the system evaluates the action-to-API conversion (Operation 407). The system accesses an advanced LLM and provides the thought, the action, and the information about the available APIs. The system also provides instructions to the LLM indicating the type of desired output from the LLM. For example, the instructions may instruct the LLM to return an identifier of the API that should be chosen, given the information provided. Alternatively, the instructions may instruct the LLM to return a yes or no response indicating if the best API was chosen.

In an embodiment, the system performs a retrieval operation (Operation 408). The system creates a vector representation of a query based on the thought or sub-query using a pre-trained model such as a transformer-based model like BERT. The model converts the query into a dense vector by encoding it into a numerical format that captures its semantic meaning. This vectorized query is then compared against a pre-existing corpus of documents that has also been encoded into vector representations. The system conducts a similarity search between the query vector and the document vectors, typically using methods such as cosine similarity to measure how closely the documents align with the query.

The system retrieves a set of documents from the corpus based on their similarity scores relative to the query. The documents are then ranked according to these similarity scores, with the highest-ranking documents being those that most closely match the semantic content of the query. The system selects the top-ranked documents, often using a predefined threshold or a fixed number of documents.

In an embodiment, the system evaluates the retrieval operation (Operation 409). Retrieval evaluation logic 318 accesses a query-to-document mapping that maps expected queries to documents. The query-to-document mapping indicates which document is a document associated with a particular expected query. The mapping may be created by humans reviewing the available documents and then providing expected queries that may be answered by the documents. These are known as “ground truth” documents for the mapped query. Ground truth information can be stored in ground truth data 352, a data set within storage 350 in an embodiment.

In accordance with one or more embodiments, retrieval evaluation logic 318 compares thoughts and/or sub-queries generated by thought module 304 with queries in the query-to-document mapping to determine which documents are ground truth documents for the sub-queries or thoughts. Retrieval evaluation logic determines if one of the documents selected by retrieval module 318 is a ground truth document. A metric is used to indicate if the retrieval was effective. Over a number of queries, the effectiveness of the retrieval module 308 can be determined by tracking the percentage of queries that resulted in retrieval of a ground truth document for the particular query.

In accordance with one or more embodiments, retrieval module may select a set of documents deemed to be relevant to the query. Retrieval evaluation logic 318 may generate a mean reciprocal rank (MRR) score for a set of queries over time. This may be performed by determining the rank of highest-ranking document that is a ground truth document. For example, if three documents are selected by retrieval module 308 and the highest-ranking document is not a ground truth document for the query, but the second document and the third document are both ground truth documents for the query, then the second document is identified as the highest-ranking ground truth document.

In an embodiment, the system generates response (Operation 410). The relevant document, along with the original query, is passed to the generation module. The generation module processes the input by first encoding both the query and the retrieved document. The encoding process involves converting the text into vector representations using a transformer model. These vectors capture the semantic relationships within the text, allowing the model to understand the context provided by the document in relation to the query.

Once the encoding is complete, the generation module enters the decoding phase. The decoder takes the encoded vectors and begins generating a response by predicting the next token in the sequence. The generation is conditioned on both the query and the context from the retrieved document. The model evaluates potential next tokens by considering the probability distribution over its vocabulary, heavily influenced by the information in the document.

The process of token generation continues iteratively. At each step, the model uses the tokens generated so far, along with the encoded context, to predict the next token. This iterative process continues until the model generates a complete and coherent response, typically ending when an end-of-sequence token is produced or when a predefined length limit is reached. The response generated by the model reflects the information provided by the specific document, ensuring that the final output is closely aligned with the content of the document while directly addressing the query.

In an embodiment, the system evaluates the response generation (Operation 411). To generate a generation metric, generation evaluation logic 320 leverages an LLM, such as LLM A 342 or LLM B 344. These LLMs may be any large language model, including state-of-the-art LLMs. In an embodiment, generation evaluation logic 320 submits, to the selected LLM the document retrieved, the initial query submitted to the RAG system 300, along with instructions. To generate an answerability metric, the generation evaluation logic 320 will use instructions that tell the LLM to indicate if the query can be effectively responded to by using the information in the retrieved document. The answerability metric can be a binary yes/no, or it may be a ranking that indicates how well the query can be answered by the document. To generate a grounding metric or hallucination metric, generation evaluation logic 320 submits the retrieved document and the query response, along with instructions. The instructions sent to the LLM by generation evaluation logic 320 may request that the LLM determine if the answer provided in response to the query is grounded in the retrieved document. Stated another way, the question posed to the LLM asks if the information presented to the user in response to the query can even be derived from the document.

In an embodiment, an analysis of the overall usability of the RAG system may be performed. A set of queries may be submitted to the system, and the metrics may be tracked over the set of queries. The metrics may be stored in a metric repository that is part of storage 350. By averaging out the metrics over the set of queries, a developer of a RAG system may be able to determine which module needs the most attention. For example, if the system consistently retrieves the wrong document for queries or the ranking of the ground truth document is low, then the retrieval logic may need to be reconfigured or retrained.

In an embodiment, a general usability score may be generated to capture the perspective of a user, and the usability score may be provided to the user of the system. For example, the system may submit the document selected by the system, the query submitted, and instructions. The instructions may instruct the LLM to determine if the particular document can be relied upon for generating a valid answer in response to the particular query. In addition, the instructions may instruct the system to determine if the response to the particular query can be reasonably derived from the particular document. From a user experience perspective, the answer to both of these questions should be yes. If the answer to both of the questions is yes, then the score increases. Otherwise, the score decreases. Over a set of queries, the score may be calculated by dividing the number of times the answer to both questions was yes by the number of queries in the set.

In an embodiment, the metrics collected over a series of queries may be input into an LLM to determine which modules require the most attention. The LLM is provided with detailed information about the operation of the modules, the way the metrics are calculated, and a series of questions designed to pinpoint areas of opportunity. For example, the questions may include questions about which scores are more impactful to the system, given the relationship between the scores shown in the data set.

In another embodiment, the metrics collected over a series of queries may be input into an LLM to generate a more complete data set. For example, due to system errors, it is possible that not all scores are generated. By performing an analysis on the data set, the LLM may “fill in” values for missing values based on trends and other similarly scored query iterations. For example, if a comparison between two query iterations (of different queries) results in a highly similar set of scores, except one score is missing for one of the iterations, then the missing score is expected to be similar to the score of the compared iteration.

In accordance with one or more embodiments, once metrics are generated, the system may present a user of the system with options and/or suggestions for making changes to the system. Alternatively, the system may automatically make changes to system configuration settings. In an embodiment, parameters and hyperparameters associated with LLMs used by the system may be altered in response to identifying a sub-optimal metric.

In an embodiment, if a response generation metric indicates excessive inference, the system suggests or initiates a change to the temperature setting. When the system changes the temperature setting, it adjusts the randomness of token selection during processing. The temperature setting controls the level of variability in the probability distribution for token predictions, directly affecting the diversity of output sequences. A lower temperature setting reduces randomness, favoring higher-probability tokens, while a higher setting increases randomness, allowing for a broader range of token choices. To modify the temperature setting, the system applies a scaling factor to the logits, the raw prediction scores before converting into probabilities. Adjustments to the temperature setting scale these logits up or down, impacting the sharpness of the probability distribution. The recalibrated temperature setting enables the system to produce outputs with varying degrees of predictability, adjusting token selection based on the desired balance between coherence and diversity in the sequence.

In an embodiment, if the query deconstruction metric indicates that the system's ability to comprehend what is being asked is impaired, the system adjusts the query attention weighting setting. When the system makes changes to the query attention weight setting, it adjusts the assignment of attention weights during processing. The query attention weight setting defines the weight given to each token in relation to other tokens within an input sequence that serves to model dependencies accurately between tokens. The query attention weight setting functions by generating a query vector for each token; each query vector combines with corresponding key vectors to produce attention scores. These scores dictate the influence each token has on subsequent representations. To adjust the query attention weight setting, the system recalibrates the parameters governing query and key vector alignment, typically through scaling factors or fine-tuning coefficients. Modifications apply directly to the calculations within the attention layer, affecting the distribution of attention weights dynamically across different input sequences. The recalibrated query attention weight setting allows the system to adapt the focus assigned to individual tokens based on contextual relevance within the sequence.

In an embodiment, if the mean reciprocal rank metric indicates that relevant documents are not being identified before irrelevant documents, the system may fine-tune relevance score thresholds that determine which documents are considered a high priority. For example, a stricter threshold can filter out less relevant documents, while a more relaxed threshold might bring more documents into consideration.

In an embodiment, if the system determines that a metric or output is sub-optimal, other suggestions may be provided to the user. For example, if the system determines that a document identified as relevant to a query is not actually relevant to that query, the system may provide a list of queries that are mapped to the document in a document-to-query mapping. As another example, if the system determines that a poor result is due to a poorly-formed prompt or query, the system may respond with prompt suggestions that are based on queries stored in the query-to-document mapping.

### 6. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

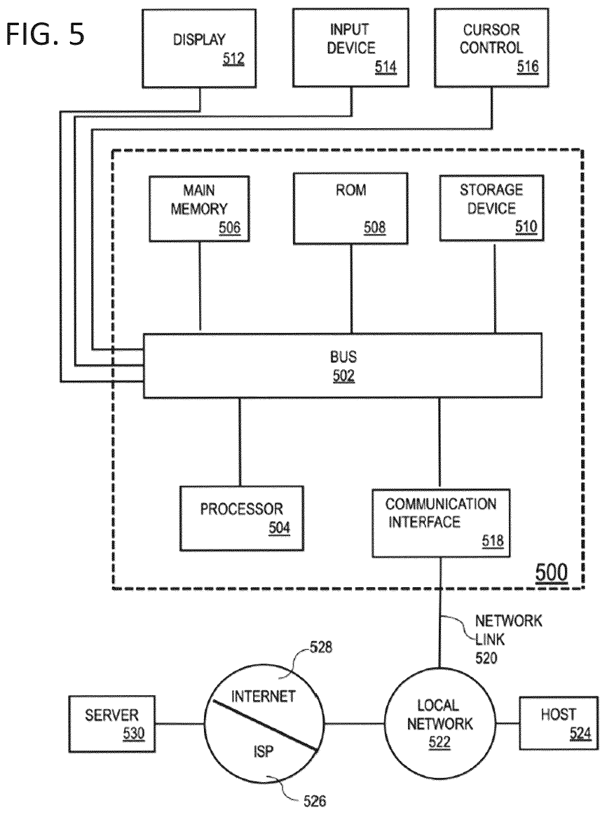

For example, FIG. 5 is a block diagram that illustrates a computer system 500 upon which an embodiment of the disclosure may be implemented. Computer system 500 includes a bus 502 or other communication mechanism for communicating information, and a hardware processor 504 coupled with bus 502 for processing information. Hardware processor 504 may be, for example, a general-purpose microprocessor.

Computer system 500 also includes a main memory 506, such as a random-access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or a Solid-State Drive (SSD) is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
accessing a first query at a system;
selecting an action from a set of available actions to perform in connection with the query;
performing the action in response to the first query;
performing a RAG core analysis, comprising:
providing, to a first LLM:
the set of available actions,
information associated with the first query,
the selected action,
first instructions for metric generation, and
receiving, from the first LLM, a core metric that is consistent with the first instructions; and
based at least in part of the core metric, the retrieval metric and the response generation metric, presenting, to a first user, an evaluation of the system.

2. The non-transitory media of claim 1, wherein the operations further comprise instructions that, when executed by one or more hardware processors, cause:
based at least in part on the evaluation of the system, presenting, to the first user, one or more suggested configuration options to configure the system.

3. The non-transitory media of claim 1, wherein the operations further comprise:
based at least in part on the evaluation of the system, altering configuration options to configure the system.

4. The non-transitory media of claim 1, wherein the operations further comprise:
performing a document retrieval process, comprising:
based on determining that a first document is relevant to the first query, retrieving the first document;
performing a retrieval analysis, comprising:
accessing a query-to-document mapping; and
determining whether the first document is mapped to a query that is similar to at least a portion of the first query.

5. The non-transitory media of claim 4, wherein the retrieval analysis further comprises generating a retrieval metric that indicates the effectiveness of the document retrieval process, wherein the value of the metric is based at least in part on whether the first document is mapped to a query that is similar to at least a portion of the first query.

6. The non-transitory media of claim 4, wherein the operations further comprise:
in response to determining that the first document is not mapped to a query that is similar to at least a portion of the first query, presenting to the first user one or more queries that are mapped to the first document.

7. The non-transitory media of claim 1, wherein the operations further comprise:
based on determining that a first document is relevant to the first query, retrieving the first document;
generating a response to the first query using a response generation process, comprising:
submitting a second query comprising the first document and second instructions for response generation to a second LLM; and
receiving a response to the second query from the second LLM.

8. The non-transitory media of claim 7, wherein the operations further comprise performing a response generation analysis, comprising:
submitting a third query to a third LLM, the third query comprising the first document;
receiving a response to the third query from the third LLM; and
based at least in part on the response to the third query, generating a response generation metric that indicates the effectiveness of the response generation process.

9. The non-transitory media of claim 8, wherein the third query further comprises:
the response to the second query;
the first query; and
third instructions for response generation to the third LLM, wherein the third instructions instruct the third LLM to perform at least one analysis of the relationship between the query and the first document.

10. The non-transitory media of claim 9, wherein the third instructions further comprise:
instructions to determine whether the first document can be relied upon for generating a valid answer in response to the first query; and
instructions to determine whether the response to the first query can be reasonably derived from the first document.

11. The non-transitory media of claim 10, wherein the operations further comprise:
in response to determining that the response generation metric indicates excessive inference, adjusting the temperature setting for the system.

12. The non-transitory media of claim 1, wherein the operations further comprise deconstructing the first query into two or more sub-queries, and performing a RAG core analysis further comprises:
performing a query deconstruction analysis, comprising:
accessing a query-to-sub-query mapping;
determining whether the two or more sub-queries are mapped to a query that is similar to at least a portion of the first query; and
generating a query deconstruction metric that indicates the effectiveness of the query deconstruction process.

13. The non-transitory media of claim 12, wherein the operations further comprise:
based at least in part on the query deconstruction metric, adjusting the query attention weighting setting for the system.

14. The non-transitory media of claim 12, wherein the operations further comprise:
determining that a first document, a second document, and a third document are relevant to the first query;
retrieving the second document and the third document; and
wherein performing a retrieval analysis further comprises:
generating a mean reciprocal rank metric based at least in part on the ranking of the first document, the second document, and the third document during the retrieval process.

15. The non-transitory media of claim 14, wherein the operations further comprise:
based at least in part on the mean reciprocal rank metric, adjusting relevance threshold settings related to document ranking.

16. One or more non-transitory computer readable media comprising instructions which, when executed by one or more hardware processors, cause performance of operations comprising:
receiving a plurality of queries;
for each particular query of the plurality of queries:
performing a document retrieval process, comprising:
determining that a particular document is relevant to the particular query, and
retrieving the particular document;
generating a response to the particular query using a query generation process, comprising:
submitting the particular document and instructions for response generation to a first LLM, and
receiving a response from the first LLM;
performing a response generation analysis, comprising:
submitting the particular document and the particular query to a second LLM; and
generating a response generation metric that indicates the effectiveness of the document retrieval process based at least in part on the response generation analysis for each query of the plurality of queries.

17. The non-transitory media of claim 16, wherein performing the response generation analysis further comprises determining whether both a) the document can be relied upon for generating a valid answer in response to the particular query, and b) the particular response can be reasonably derived from the particular document.

18. The non-transitory media of claim 17, wherein performing the response generation analysis further comprises:
submitting, to the second LLM:
instructions to determine whether the particular document can be relied upon for generating a valid answer in response to the particular query; and
instructions to determine whether the response to the particular query can be reasonably derived from the particular document.

19. The non-transitory media of claim 18, wherein the operations further comprise:
in response to determining that the response generation metric indicates excessive inference, adjusting the temperature setting for the system.

20. A method, comprising:
accessing a first query at a system;
selecting an action from a set of available actions to perform in connection with the query;
performing the action in response to the first query;
performing a RAG core analysis, comprising:
providing, to a first LLM:
the set of available actions;
information associated with the first query;
the selected action;
first instructions for metric generation;
receiving, from the first LLM, a core metric that is consistent with the first instructions;
based at least in part of the core metric, the retrieval metric and the response generation metric, presenting, to a first user, an evaluation of the system; and
wherein the method is performed by at least one device including a hardware processor.
